(19) United States
(12) Patent Application Publication
(10) Pub. No.: US 2026/0370260 A1
(43) Pub. Date: Nov. 19, 2026

(54) WIRELESS POWER TRANSFER SYSTEM WITH SPREAD SPECTRUM COMMUNICATIONS

(71) Applicant: Apple Inc., Cupertino, CA (US)

(72) Inventors: Sriram Narayanan, Los Gatos, CA (US); Stephen C. Terry, San Jose, CA (US); Arash Mehrabi, Menlo Park, CA (US); Alireza Safaee, San Jose, CA (US)

(21) Appl. No.: 19/303,859

(22) Filed: Aug. 19, 2025

Related U.S. Application Data
(60) Provisional application No. 63/806,905, filed on May 16, 2025.

(51) Int. Cl. H04B 5/79; H02J 50/12; H02J 50/70; H02J 50/80; H04B 1/707

(52) U.S. Cl. CPC H04B 5/79; H02J 50/12; H02J 50/70; H02J 50/80; H04B 1/707

(57) ABSTRACT

A wireless power receiver can include a wireless power transfer coil; a rectifier coupled to the wireless power transfer coil that converts an AC voltage induced in the wireless power transfer coil by a wireless power transmitter to a DC output voltage; and control circuitry that operates the rectifier to selectively short circuit the wireless power transfer coil to communicate with the wireless power transmitter using amplitude shift keying communication, wherein the rectifier selectively short circuits the wireless power transfer coil at one half the rectifier’s DC output voltage to reduce common mode noise caused by communication with the wireless power transmitter.

### CROSS-REFERENCE TO RELATED APPLICATIONS

This application claims priority to U.S. Provisional Application No. 63/806,905 filed May 16, 2025 and entitled “Wireless Power Transfer System with Signal Energy Computation Communications Circuitry”; which is incorporated by reference herein in its entirety.

### BACKGROUND

Wireless power transfer is used in various electronic devices. For example, smart phones, tablet computers, smart watches, wireless earphones, styluses, etc. may employ wireless power transfer to facilitate charging of batteries within the devices and/or to power the devices during operation.

### SUMMARY

A wireless power receiver can include a wireless power transfer coil; a rectifier coupled to the wireless power transfer coil that converts an AC voltage induced in the wireless power transfer coil by a wireless power transmitter to a DC output voltage; and control circuitry that operates the rectifier to selectively short circuit the wireless power transfer coil to communicate with the wireless power transmitter using amplitude shift keying communication, wherein the rectifier selectively short circuits the wireless power transfer coil at one half the rectifier’s DC output voltage to reduce common mode noise caused by communication with the wireless power transmitter.

The amplitude shift keying communication can use a spread spectrum communication technique in which each 1 bit to be communicated is replaced with a first sequence of chips, and each 0 bit to be communicated is replaced with a second sequence of chips. The spread spectrum communication technique can employ differential direct sequence spread spectrum communication in which each chip is encoded by a high-to-low or low-to-high transition of the voltage across or current through the wireless power transfer coil. The control circuitry can send an idle pattern between communication packets. The idle pattern comprises a sequence of 1 bits.

The rectifier can be a full bridge rectifier, and the control circuitry operates the rectifier to selectively short circuit the wireless power transfer coil by closing two low side switching devices of the rectifier. The rectifier can selectively short circuit the wireless power transfer coil at one-half the rectifier’s DC output voltage by short circuiting the wireless power transfer coil during two consecutive cycles of the AC voltage induced in the wireless power transfer coil followed by not short circuiting the wireless power transfer coil during two subsequent consecutive cycles of the AC voltage induced in the wireless power transfer coil.

A method of communicating with a wireless power transmitter, performed by control circuitry of a wireless power receiver, can include controlling a rectifier of the wireless power receiver to selectively short circuit a wireless power transfer coil of the wireless power receiver to communicate with the wireless power transmitter using amplitude shift keying communication. Selectively short circuiting the wireless power transfer coil of the wireless power receiver can be performed when a voltage across the wireless power transfer coil is at one half the rectifier’s DC output voltage, thereby reducing common mode noise caused by communication with the wireless power transmitter.

The amplitude shift keying communication can use a spread spectrum communication technique in which each 1 bit to be communicated is replaced with a first sequence of chips, and each 0 bit to be communicated is replaced with a second sequence of chips. The spread spectrum communication technique can employ differential direct sequence spread spectrum communication in which each chip is encoded by a high-to-low or low-to-high transition of the voltage across or current through the wireless power transfer coil. The method of communicating can further include controlling the rectifier to send an idle pattern between communication packets. The idle pattern can include a sequence of 1 bits.

The rectifier can be a full bridge rectifier, and short circuiting the wireless power transfer coil can include closing two low side switching devices of the rectifier. Selectively short circuiting the wireless power transfer coil of the wireless power receiver when a voltage across the wireless power transfer coil is at one half the rectifier’s DC output voltage can include short circuiting the wireless power transfer coil during two consecutive cycles of the AC voltage induced in the wireless power transfer coil followed by not short circuiting the wireless power transfer coil during two subsequent consecutive cycles of the AC voltage induced in the wireless power transfer coil.

A wireless power receiver can include a wireless power transfer coil; a rectifier coupled to the wireless power transfer coil that converts an AC voltage induced in the wireless power transfer coil by a wireless power transmitter to a DC output voltage; and control circuitry that operates the rectifier to selectively short circuit the wireless power transfer coil to communicate with the wireless power transmitter using amplitude shift keying communication. The amplitude shift keying communication can use a spread spectrum communication technique in which each 1 bit to be communicated is replaced with a first sequence of chips, and each 0 bit to be communicated is replaced with a second sequence of chips. The spread spectrum communication technique can employ differential direct sequence spread spectrum communication in which each chip is encoded by a high-to-low or low-to-high transition of the voltage across or current through the wireless power transfer coil. The control circuitry can send an idle pattern between communication packets. The rectifier can selectively short circuit the wireless power transfer coil at one half the rectifier’s DC output voltage to reduce common mode noise caused by communication with the wireless power transmitter. The idle pattern can include a sequence of 1 bits.

The rectifier can be a full bridge rectifier, and the control circuitry can operate the rectifier to selectively short circuit the wireless power transfer coil by closing two low side switching devices of the rectifier. The rectifier can selectively short circuit the wireless power transfer coil at one-half the rectifier’s DC output voltage by short circuiting the wireless power transfer coil during two consecutive cycles of the AC voltage induced in the wireless power transfer coil followed by not short circuiting the wireless power transfer coil during two subsequent consecutive cycles of the AC voltage induced in the wireless power transfer coil.

### BRIEF DESCRIPTION OF THE DRAWINGS

FIG. 1 illustrates a simplified block diagram of a wireless power transfer system.

FIG. 2 illustrates a simplified schematic diagram of a wireless power receiver.

FIG. 3 illustrates a spread spectrum communication technique that can be used with a wireless power transfer system.

FIG. 4 illustrates an exemplary communication sequence including a plurality of data packets and a plurality of filler chips.

FIGS. 5A & 5B illustrate certain waveforms of wireless power transfer systems including spread spectrum communications.

FIG. 6 illustrates a block diagram of an always on decoder block for a wireless power transmitter.

FIG. 7 illustrates a block diagram of an alternative embodiment of an always on decoder block for a wireless power transmitter.

### DETAILED DESCRIPTION

In the following description, for purposes of explanation, numerous specific details are set forth to provide a thorough understanding of the disclosed concepts. As part of this description, some of this disclosure’s drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose. Any trademarks referenced herein are intended to only to identify examples and are property of their respective owners.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

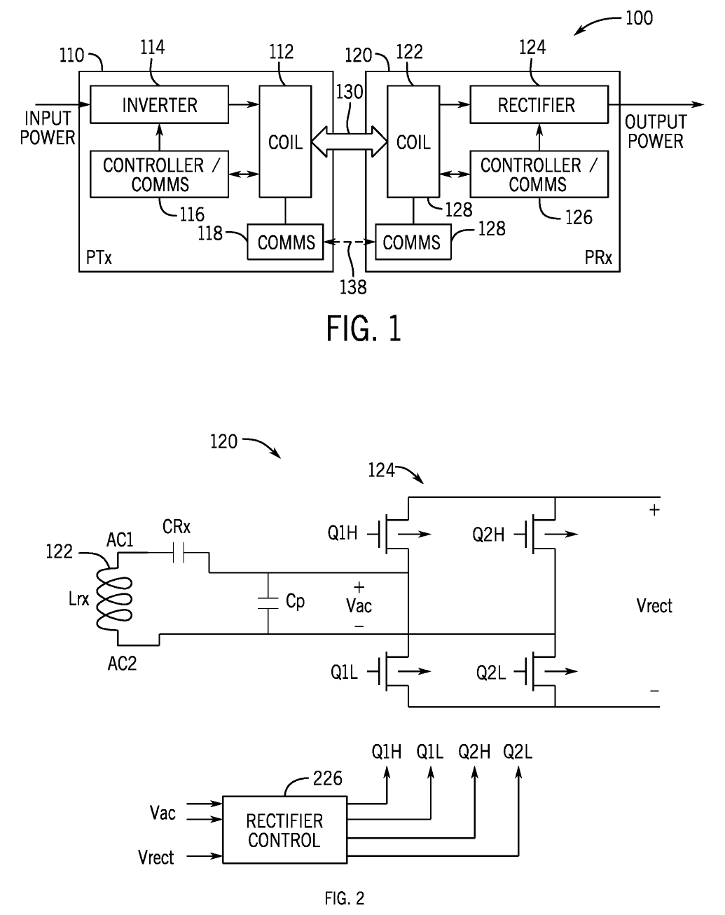

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

FIG. 2 illustrates a simplified schematic diagram of a wireless power receiver 120. Wireless power transfer coil 122 (e.g., a wireless power receiving coil) can be represented by an inductor Lrx. The respective terminals of the inductor, AC1 and AC2, can present an AC voltage induced in the wireless power transfer coil 122 by a wireless power transmitter, as described above with respect to FIG. 1. Rectifier 124 can be constructed from a full bridge of switching devices Q1H, Q1L, Q2H, Q2L. The AC1 terminal of wireless power transfer coil 122 can be coupled to a switch node of a first half bridge made up of high side switching device Q1H and low side switching device Q1L by a tuning capacitor CRx. The AC2 terminal of wireless power transfer coil 122 can be coupled to a switch node of a second half bridge made up of high side switching device Q2H and low side switching device Q2L. The DC output of rectifier 124, Vrect, can be taken across the full bridge. An additional input filter capacitor Cp can be coupled between the respective switch nodes of the respective half bridges.

Rectifier control circuitry 226, which can be part of PRx controller and communications circuitry 126 described above with reference to FIG. 1, can be used to control the rectifier switching devices. This control may be responsive to the AC voltage Vac appearing at the input to the rectifier (which corresponds to the AC voltage between the AC1/AC2 terminals of wireless power transfer (receiving) coil 122. Control of the rectifier switching devices may also be responsive to the rectifier output voltage Vrect. Rectifier control circuitry 226 can thus generate gate drive signals for the respective switching devices Q1H, Q1L, Q2H, Q2L to convert the input AC voltage Vac to the DC output voltage Vrect. This can be achieved by switching between a first switching state in which switching devices Q1H and Q2L are turned on (thereby allowing current to flow from AC1 to AC2 through a load connected to the rectifier output) and a second switching state in which switching devices Q2H and Q1L are turned on (thereby allowing current to flow from AC2 to AC1 through a load connected to the rectifier output).

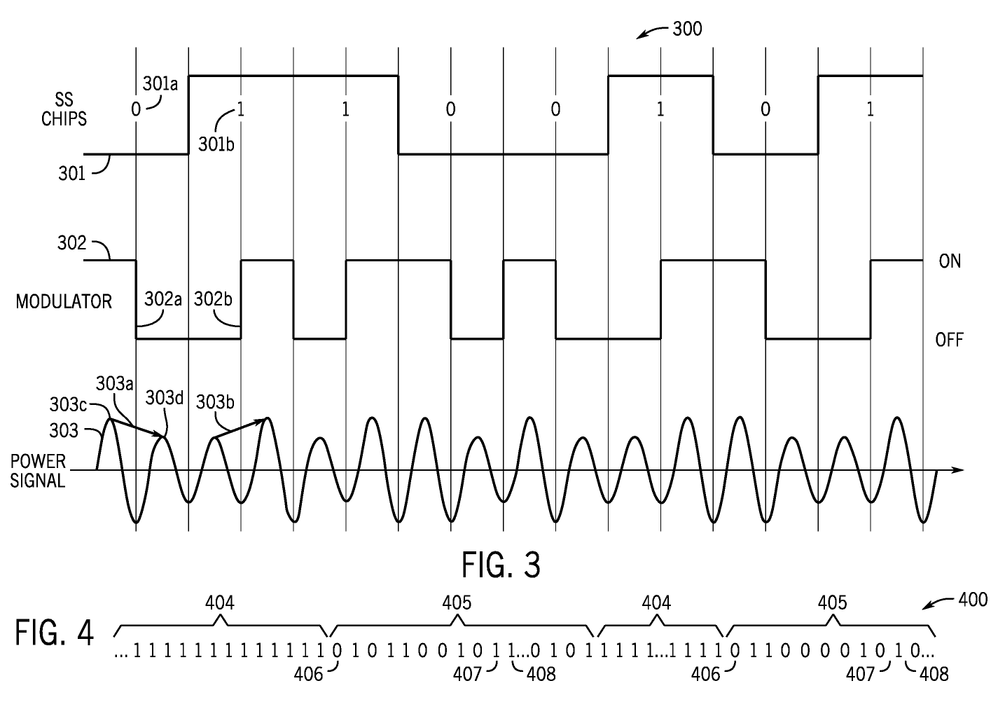

As described above, some wireless power transfer systems may employ in-band communications from a wireless power receiver to a wireless power transmitter. In some cases, this may be done by using ASK communication, in which the wireless power receiver modulates the load presented to the wireless power transfer (receiving) coil 122, which is thus reflected to the wireless power transmitter in a way that the wireless power transmitter can detect and decode. One way to achieve such ASK communication with a wireless power receiver as depicted in FIG. 2 is to intermittently switch the switching devices to a third switching state in which high side switches Q1H and Q2H are both turned off and low side switches Q1L and Q2L are both turned on. This can be considered as “short-circuiting” the wireless power transfer (receiving) coil 122, which is a change in load that can be detected by the wireless power transmitter. Although colloquially described as “short-circuiting” the wireless power transfer coil 122, as understood by those skilled in the art, the coil may not be truly short circuited, as circuit elements such as tuning capacitor CRx may remain in the current path. Nonetheless, a switching operation such as the described third switching state can nonetheless present a load modulation that can be detected by the wireless power transmitter (e.g., by controller and communication circuitry 116 of the wireless power transmitter 110, as described above with reference to FIG. 1. Further details of such switching are described below with reference to FIGS. 3–5.

FIG. 3 illustrates a spread spectrum communication technique that can be used with a wireless power transfer system in the form of a plot 300 of a series of waveforms 301–303. More specifically, FIG. 3 illustrates a direct sequence spread spectrum (DSSS) communication technique in which each data bit to be communicated is replaced with a sequence of “chips,” i.e., a sequence of highs or lows to represent each data bit. Thus, a data bit having a value of 1 may be replaced by a first sequence of chips, e.g., 8 chips, while a data bit having a value of zero may be replaced by a second sequence of chips, e.g., 8 chips. The respective chip sequences corresponding to respective values of the data bit may each have what is effectively a pseudo-random order, the effect of which is to “spread the spectrum” of the original stream of data bits. In the case of communication between a wireless power receiver and a wireless power transmitter, the data bits can be a sequence of 1’s and 0’s corresponding to various messages in accordance with the Qi family of wireless power transfer standards promulgated by the Wireless Power Consortium or other communication protocol definitions. In other words, the data bits can be a sequence of Qi symbols encoded, e.g., using Qi bi-phase encoding.

One variation of DSSS encoding is differential direct sequence spread spectrum (“DDSSS”) in which each chip is encoded by a high-to-low or low-to-high transition of an underlying waveform, which could also be called a differential chip symbol. Turning back to FIG. 3, a series of waveforms depicting a DDSSS communication arrangement are presented. Waveform 301 corresponds to a sequence of spread spectrum chips that can replace a single data bit of the underlying data stream. The illustrated chip sequence is 01100101, which could, for example, be used to represent a single 1 bit in the underlying data stream. An alternative chip sequence could be used to represent a 0 bit in the underlying data stream.

Waveform 302 corresponds to a modulator output that produces the differentially encoded chips. Thus, a falling edge 302a of waveform 302 can correspond to a “0” or “low” chip (e.g., 301a), and a rising edge 302b can correspond to a “1” or “high” chip (e.g., 301b). The modulator can be part of the wireless power receiver control and communication circuitry 126, such as being part of or coupled to the rectifier control circuitry 226. The modulator can interface with the rectifier switching devices to selectively activate the third switching state at appropriate timings with respect to the AC power waveform 303. The net result of such a modulation is that the magnitudes of the peaks 303c/303d of the power signal delivered from the wireless power transmitter to the wireless power receiver will alternate between higher and lower values as the modulator creates the rising edges 302a/302b that encode the 0/low or 1/high chips 301a/301b, as described above. Thus, a decrease 303a in the peak magnitude of power signal 303 can correspond to the falling edge 302a, and an increase 303b in the peak magnitude of power signal 303 can correspond to a rising edge 302b, thus generating the chips 301a/301b described above, a sequence of which will correspond to the data bits of the underlying Qi data to be communicated from the wireless power receiver to a wireless power transmitter.

FIG. 4 illustrates an exemplary continuous modulation communication sequence 400 including a plurality of data packets 405 and a plurality of filler bits 404. Filler bits 404, also called an idle pattern, may include an arbitrary length, continuous sequence of 1/high bits or any other suitable pattern. For example, the illustrated sequence of 1/high bits may be useful in connection with bi-phase encoding in which the modulator can be driven with a 1-0-1-0… sequence. For other encoding schemes, such as normal signaling (i.e., not bi-phase encoding), the idle pattern could be 1-0-1-0…. Data packets 405 can include a sequence of bits corresponding to a communication protocol, such as those described in the Qi standard. Each data packet may include a start bit 406, which can be a 0 bit (to distinguish the idle pattern). Each data packet may also include a stop bit 407 and a parity bit 408 to assist with decoding of the data packet.

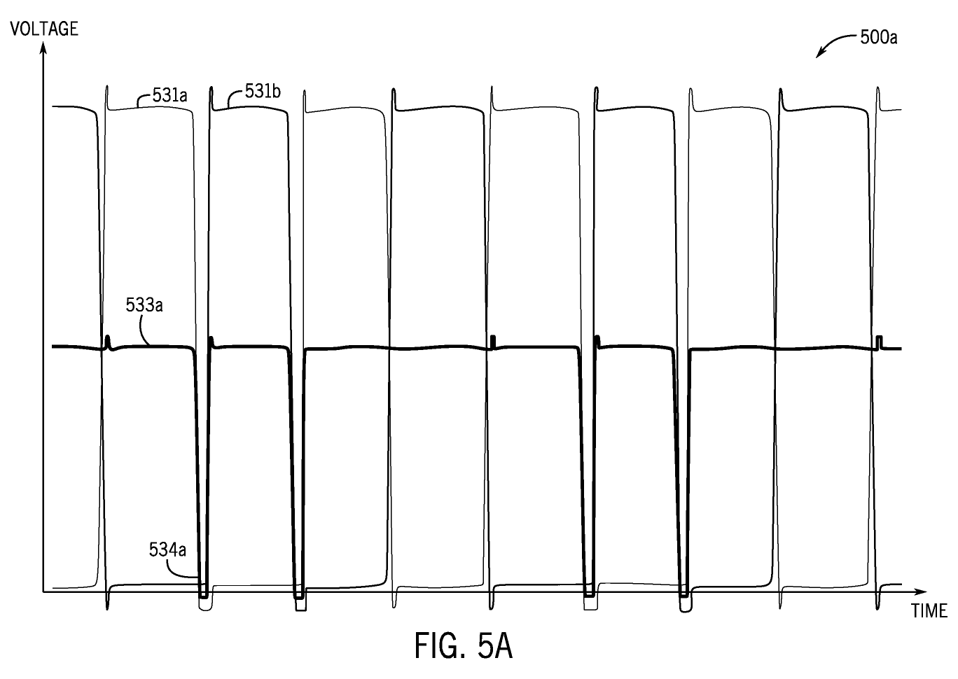

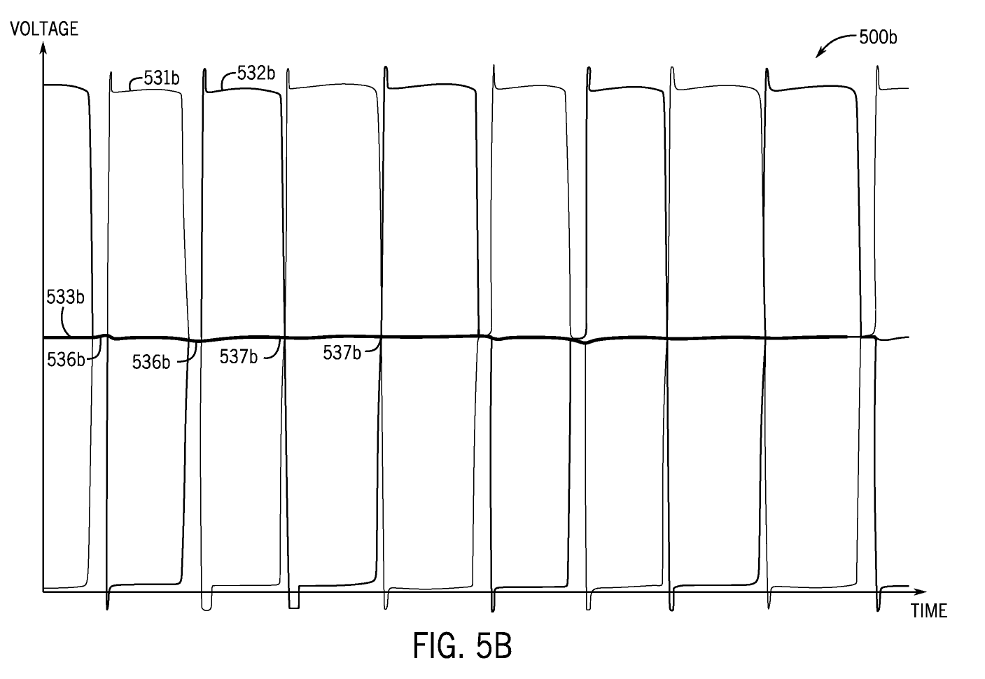

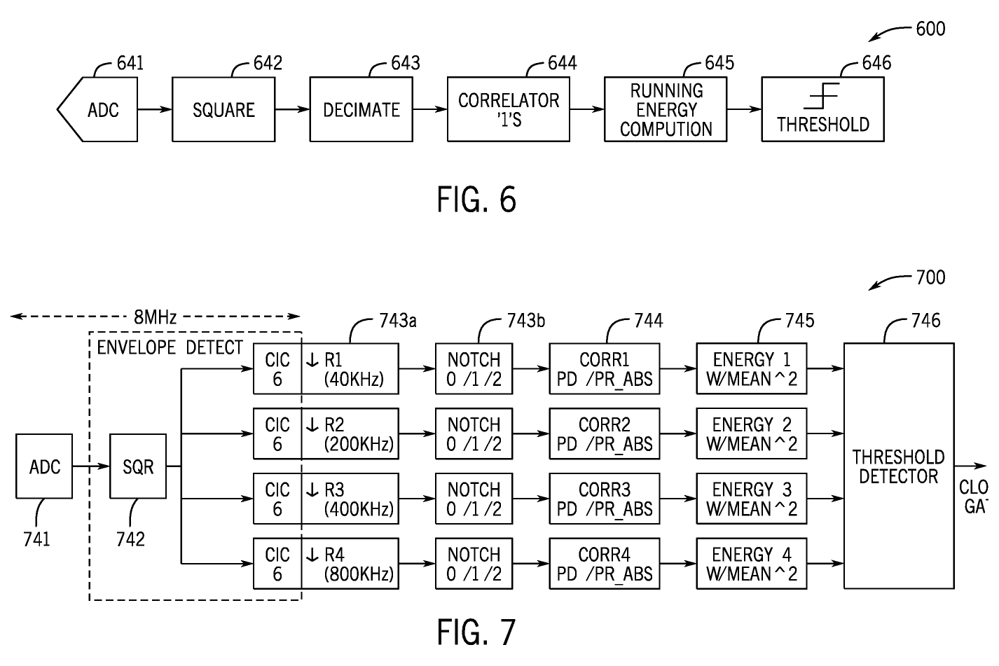

Advantages of such a continuous modulation arrangement in a wireless power receiver ASK communication arrangement—e.g., including the idle sequence of 1 bits (for bi-phase encoding) between data packets—can include reducing randomness outside data packets (enabling use of lower thresholds), improved stability of the rectifier output voltage (Vrect), and reduced audible noise of the communications technique. Conversely, a non-continuous modulation technique, when the power waveform is modulated only when an ASK communication packet is being sent from wireless power receiver to wireless power transmitter, may result in increased audible noise (depending on power and communication frequencies used), greater variation in the rectifier output voltage Vrect, etc. However, continuous modulation can potentially present issues on both the wireless power receiver and wireless power transmitter side. For example, on the wireless power transmitter side such modulation may result in increased common mode noise, which can, in at least some embodiments, be addressed as described below with reference to FIG. 5. As another example, on the wireless power transmitter side, such continuous modulation may result in increased power consumption and decreased efficiency, which can, in at least some embodiments, be addressed as described below with reference to FIGS. 6 and 7.

FIGS. 5A and 5B illustrate certain waveforms of wireless power transfer systems implementing DDSSS communication for ASK communication from wireless power receiver to wireless power transmitter as described above. In FIG. 5A, plot 500a illustrates an arrangement in which the wireless power receiver intermittently uses the third switching state that short circuits the wireless power receiving coil (i.e., nodes AC1/AC2) at zero voltage, i.e., when there is no voltage appearing across capacitor Cp illustrated and described above with reference to FIG. 2. This can be used for at least two purposes. First, in every half cycle, the rectifier control circuitry 226 can close both low side switches Q1L/Q2L for a certain time (tSHORT). By thus effectively short circuiting the wireless power receiving coil, the wireless power transmitter stores some energy into the wireless power transfer coil, in a manner of operation similar to a boost converter. This can effectively boost the input voltage to the rectifier. Such short circuits may be performed for a relatively short period of time (e.g., 20 to 200ns) as compared to the switching frequency (e.g., on the order of 100s of kHz).

In addition to the above-described boosting function, the switch short circuiting can also be used for communication, as briefly described above with reference to FIG. 2. More specifically, the short-circuiting time (tSHORT) can be alternated between two different values (tSHORT1/tSHORT2). For example, the two short circuit times could be 0ns and 100ns, 50ns and 150ns, etc. The switching between short circuiting values can create the communication modulation. As one example, computing at 2kb/s could involve employing tSHORT1 for 250μs and tSHORT2 for 250μs, where within each bit the specified tSHORT value is applied on each switching point. Such an arrangement is illustrated in plot 500a of FIG. 5.

In plot 500a, waveform 531a corresponds to the voltage of the AC1 (referenced to ground), and waveform 532a corresponds to the voltage of the AC2 terminal (referenced to ground). Shorting the wireless power receiving coil at ground creates spikes 534a, which alternate between positive and negative, in the common mode voltage 533a. These common mode voltage spikes can be undesirable from an EMC electromagnetic compatibility perspective as the common mode noise can cause undesirable interaction with other circuits and devices.

Alternatively, in FIG. 5B, plot 500b illustrates an arrangement in which the wireless power receiver intermittently the third switching state that short circuits the wireless power receiving coil (i.e., nodes AC1/AC2) at Vrect/2, i.e., when a voltage equal to half the rectifier output voltage (Vrect) appears across capacitor Cp illustrated and described above with reference to FIG. 2. In plot 500b, waveform 531b corresponds to the voltage of the AC1 terminal (referenced to ground), and waveform 532b corresponds to the voltage of the AC2 terminal (referenced to ground). Shorting the wireless power receiving coil at Vrect/2 corresponds to short circuiting the wireless power receiving coil on two consecutive half cycles 536b of the AC waveform skipping alternating consecutive half cycles 537b. This significantly reduces/substantially eliminates the common mode voltage spikes 534a, resulting in a substantially constant common mode voltage 533b. This can correspondingly result in much improved EMC performance.

As described above, use of continuous modulation DDSSS modulation as described with reference to FIG. 4 may result in increased power consumption and decreased efficiency on the wireless power transmitter side. This can, in at least some embodiments, be addressed as described below with reference to FIGS. 6 and 7. A more specific statement of the issue is that because the wireless power receiver can transmit data to the wireless power transmitter at any time, the wireless power transmitter must continuously run its demodulator circuitry. During periods where only the idle sequence is sent, the decoder circuitry will be expending energy to “decode” these bits, which contain no useful data and are thus discarded. Nonetheless, the decoding of these “meaningless” bits nonetheless increases energy consumption and thus thermal losses associated with the wireless power transmitter controller circuitry. As a result, it would be desirable to operate the decoder circuitry only during intervals where meaningful data is being received. Such an arrangement can employ an always on decoder block capable of operating at lower power that can monitor the load presented to the wireless power transmitter by the wireless power receiver and ignore the idle sequence while triggering the full decoder when an actual data packet is received. This can reduce power consumption during the idle sequence because only the relatively lower power always on decoder block need be operating, rather than the full communication circuitry.

FIG. 6 illustrates a block diagram of an always on decoder block 600 for a wireless power transmitter. The always on decoder block can be implemented as part of the wireless power transmitter control and communication circuitry 116 described above with reference to FIG. 1. The always on decoder block 600 can monitor the power delivered by the wireless power transmitter (which corresponds to the power received by the wireless power receiver and is being modulated by the wireless power receiver to communicate with the wireless power transmitter. The always on decoder block can further extract the envelope of the power carrier and compute the energy at a particular frequency. The transmission during idle periods can be characterized by a narrow-band signature (e.g., all 1’s as described above would correspond to a tone at the symbol frequency). When an actual message packet/pattern begins, the energy at the narrow-band frequency will drop because the real message will have a mixture of 1 and 0 bits. In response to this energy drop always on decoder can trigger (turn on) the full decoder circuitry to decode the received bitstream. It will be appreciated that some buffering of the incoming data may be required to allow the full decoder to catch-up after being started.

In FIG. 6, always on decoder block can include an analog to digital converter 641 that can digitize samples of the delivered power waveform, e.g., samples of the voltage and/or current delivered via the wireless power transmitting coil. These values can be squared (block 642) and decimated (643), with a certain fraction of samples being discarded to reduce the effects of noise and also reduce computational complexity, which can further reduce power consumption. The decimated data can then be provided to a correlator 644, which can effectively compare the decimated data to that expected with a signal of all 1s (or other idle sequence). In other words, the correlator 644 can act as a band-pass filter centered at a frequency corresponding to a signal of all 1 bits corresponding to the idle sequence described above. The output of this correlator/filter can be provided to an energy computation block 645, which can detect the above-described reduction in energy at the frequency corresponding to the idle bit sequence, with the energy level being provided to a threshold detector 646. Once the energy level drops below the threshold, indicating that data other than the idle sequence is being sent, the threshold detector can trigger the full communication decoder circuitry (e.g., another part of wireless power transmitter control and communication circuitry 116 described above with reference to FIG. 1), which can then decode the received signal as normal.

FIG. 7 illustrates a block diagram of an alternative embodiment of an always on decoder 700 for a wireless power transmitter. Like reference numbers have been used for corresponding components. The alternative always on decoder 700 differs from that of FIG. 6 is that it operates in four parallel streams at four different operating frequencies so as to be usable with wireless power transmitters that operate at different data rates, without the data rate having to be explicitly set by communication between the wireless power receiver and the wireless power transmitter or other mechanism. In the illustrated example, the four parallel streams can operate at frequencies of 40kHz, 200kHz, 400kHz, and 800kHz, corresponding to a combined bandwidth of 8MHz, although implementations at a variety of data rates and overall bandwidths are also possible.

In any case, analog to digital converter 741 correspond to analog to digital converter 641 described above and digitizes samples of the delivered power waveform, e.g., samples of the voltage and/or current delivered via the wireless power transmitting coil. These values can be squared (block 742), and decimated (blocks 743a/743b in each parallel stream). The decimated data streams can be provided to correlators 744, which operate as described above with respect to correlator 644, just at the different data rate frequencies described above. Then, energy computation blocks 745 for each data stream can compute the energy associated with the output of the correlators 744, which can then be fed to a threshold detector 746, which can trigger the full decoder circuitry, which can then act on the incoming data, with suitable buffering, etc. if required to account for any delays between receipt of the initial data stream and restarting of the full decoder circuitry.

Described above are various features and embodiments relating to wireless power transfer devices incorporating spread spectrum communications. Such arrangements may be used in a variety of applications but may be particularly advantageous when used in conjunction with electronic devices such as mobile phones, tablet computers, laptop or notebook computers, and wireless power receivers including accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices’ ability to provide wireless power signals to each other in an efficient manner to facilitate battery charging, such as by sharing of the devices’ power handling capabilities with one another. Entities implementing the present technology should take care to ensure that, to the extent the communication techniques described herein are used to transmit sensitive information via inductive channels, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A wireless power receiver comprising:
a wireless power transfer coil;
a rectifier coupled to the wireless power transfer coil that converts an AC voltage induced in the wireless power transfer coil by a wireless power transmitter to a DC output voltage; and
control circuitry that operates the rectifier to selectively short circuit the wireless power transfer coil to communicate with the wireless power transmitter using amplitude shift keying communication, wherein the rectifier selectively short circuits the wireless power transfer coil at one half the rectifier’s DC output voltage to reduce common mode noise caused by communication with the wireless power transmitter.

2. The wireless power receiver of claim 1 wherein the amplitude shift keying communication uses a spread spectrum communication technique in which each 1 bit to be communicated is replaced with a first sequence of chips, and each 0 bit to be communicated is replaced with a second sequence of chips.

3. The wireless power receiver of claim 2 wherein the spread spectrum communication technique employs differential direct sequence spread spectrum communication in which each chip is encoded by a high-to-low or low-to-high transition of the voltage across or current through the wireless power transfer coil.

4. The wireless power receiver of claim 1 wherein the control circuitry sends an idle pattern between communication packets.

5. The wireless power receiver of claim 4 wherein the idle pattern comprises a sequence of 1 bits.

6. The wireless power receiver of claim 1 wherein the rectifier is a full bridge rectifier, and the control circuitry operates the rectifier to selectively short circuit the wireless power transfer coil by closing two low side switching devices of the rectifier.

7. The wireless power receiver of claim 1 wherein the rectifier selectively short circuits the wireless power transfer coil at one-half the rectifier’s DC output voltage by short circuiting the wireless power transfer coil during two consecutive cycles of the AC voltage induced in the wireless power transfer coil followed by not short circuiting the wireless power transfer coil during two subsequent consecutive cycles of the AC voltage induced in the wireless power transfer coil.

8. A method of communicating with a wireless power transmitter, performed by control circuitry of a wireless power receiver, the method comprising:
controlling a rectifier of the wireless power receiver to selectively short circuit a wireless power transfer coil of the wireless power receiver to communicate with the wireless power transmitter using amplitude shift keying communication;
wherein selectively short circuiting the wireless power transfer coil of the wireless power receiver is performed when a voltage across the wireless power transfer coil is at one half the rectifier’s DC output voltage, thereby reducing common mode noise caused by communication with the wireless power transmitter.

9. The method of claim 8 wherein the amplitude shift keying communication uses a spread spectrum communication technique in which each 1 bit to be communicated is replaced with a first sequence of chips, and each 0 bit to be communicated is replaced with a second sequence of chips.

10. The method of claim 9 wherein the spread spectrum communication technique employs differential direct sequence spread spectrum communication in which each chip is encoded by a high-to-low or low-to-high transition of the voltage across or current through the wireless power transfer coil.

11. The method of claim 8 further comprising controlling the rectifier to send an idle pattern between communication packets.

12. The method of claim 11 wherein the idle pattern comprises a sequence of 1 bits.

13. The method of claim 8 wherein the rectifier is a full bridge rectifier, and short circuiting the wireless power transfer coil comprises closing two low side switching devices of the rectifier.

14. The method of claim 8 wherein selectively short circuiting the wireless power transfer coil of the wireless power receiver when a voltage across the wireless power transfer coil is at one half the rectifier’s DC output voltage comprises short circuiting the wireless power transfer coil during two consecutive cycles of the AC voltage induced in the wireless power transfer coil followed by not short circuiting the wireless power transfer coil during two subsequent consecutive cycles of the AC voltage induced in the wireless power transfer coil.

15. A wireless power receiver comprising:
a wireless power transfer coil;
a rectifier coupled to the wireless power transfer coil that converts an AC voltage induced in the wireless power transfer coil by a wireless power transmitter to a DC output voltage; and
control circuitry that operates the rectifier to selectively short circuit the wireless power transfer coil to communicate with the wireless power transmitter using amplitude shift keying communication;
wherein:
the amplitude shift keying communication uses a spread spectrum communication technique in which each 1 bit to be communicated is replaced with a first sequence of chips, and each 0 bit to be communicated is replaced with a second sequence of chips;
the spread spectrum communication technique employs differential direct sequence spread spectrum communication in which each chip is encoded by a high-to-low or low-to-high transition of the voltage across or current through the wireless power transfer coil;
the control circuitry sends an idle pattern between communication packets; and
the rectifier selectively short circuits the wireless power transfer coil at one half the rectifier’s DC output voltage to reduce common mode noise caused by communication with the wireless power transmitter.

16. The wireless power receiver of claim 15 wherein the idle pattern comprises a sequence of 1 bits.

17. The wireless power receiver of claim 16 wherein the rectifier is a full bridge rectifier, and the control circuitry operates the rectifier to selectively short circuit the wireless power transfer coil by closing two low side switching devices of the rectifier.

18. The wireless power receiver of claim 16 wherein the rectifier selectively short circuits the wireless power transfer coil at one-half the rectifier’s DC output voltage by short circuiting the wireless power transfer coil during two consecutive cycles of the AC voltage induced in the wireless power transfer coil followed by not short circuiting the wireless power transfer coil during two subsequent consecutive cycles of the AC voltage induced in the wireless power transfer coil.

19. The wireless power receiver of claim 15 wherein the rectifier is a full bridge rectifier, and the control circuitry operates the rectifier to selectively short circuit the wireless power transfer coil by closing two low side switching devices of the rectifier.

20. The wireless power receiver of claim 15 wherein the rectifier selectively short circuits the wireless power transfer coil at one-half the rectifier’s DC output voltage by short circuiting the wireless power transfer coil during two consecutive cycles of the AC voltage induced in the wireless power transfer coil followed by not short circuiting the wireless power transfer coil during two subsequent consecutive cycles of the AC voltage induced in the wireless power transfer coil.
